(19) United States
(12) Patent Application Publication
(10) Pub. No.: US 2012/0269172 A1
(43) Pub. Date: Oct. 25, 2012

(54) Apparatus and Method for Providing Handover Trigger Mechanisms Using Multiple Metrics

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/384,164

(22) PCT Filed: Apr. 12, 2010
(86) PCT No.: PCT/US10/30758

§ 371 Date: Jan. 13, 2012

Related U.S. Application Data
(60) Provisional application No. 61/248,643, filed on Oct. 5, 2009.

(51) Int. Cl. H04W 36/24

(52) U.S. Cl. 370/332

(57) ABSTRACT

A method and apparatus for providing handover trigger mechanisms using multiple metrics in a TD-SCDMA system is provided. The method may comprise determining if a difference between a distance from a UE to a neighbor Node B and a distance from the UE to a serving Node B meets a criteria, and determining whether to perform a handover from said serving Node B to said neighbor Node B based on whether the determined difference meets the criteria.

CROSS-REFERENCE TO RELATED APPLICATION(S)

This application claims the benefit of U.S. Provisional Patent Application No. 61/248,643, entitled “APPARATUS AND METHOD FOR PROVIDING HANDOVER TRIGGER MECHANISMS USING MULTIPLE METRICS,” filed on Oct. 5, 2009, which is expressly incorporated by reference herein in its entirety.

### BACKGROUND

1. Field

Aspects of the present disclosure relate generally to wireless communication systems, and more particularly, to provide handover trigger mechanisms using multiple metrics.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA) which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes determining if a difference between a distance from a user equipment (UE) to a neighbor Node B and a distance from the UE to a serving Node B meets a criteria, and determining whether to perform a handover from said serving Node B to said neighbor Node B based on whether the determined difference meets the criteria.

In an aspect of the disclosure, an apparatus includes means for determining if a difference between a distance from a UE to a neighbor Node B and a distance from the UE to a serving Node B meets a criteria, and means for determining whether to perform a handover from said serving Node B to said neighbor Node B based on whether the determined difference meets the criteria.

In an aspect of the disclosure, a computer program product includes a computer-readable medium which includes code for determining if a difference between a distance from a UE to a neighbor Node B and a distance from the UE to a serving Node B meets a criteria, and code for determining whether to perform a handover from said serving Node B to said neighbor Node B based on whether the determined difference meets the criteria.

In an aspect of the disclosure, an apparatus includes at least one processor, and a memory coupled to the at least one processor. In such an aspect, the at least one processor may be configured to determine if a difference between a distance from a UE to a neighbor Node B and a distance from the UE to a serving Node B meets a criteria, and determine whether to perform a handover from said serving Node B to said neighbor Node B based on whether the determined difference meets the criteria.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a UE in a telecommunications system.

FIG. 4 is a functional block diagram conceptually illustrating example blocks executed to implement the functional characteristics of one aspect of the present disclosure.

FIG. 5 is an exemplary call-flow diagram of a methodology for facilitating handover trigger mechanisms using multiple metrics according to an aspect.

FIG. 6 is an exemplary TD-SCDMA frame structures illustrating transmission and receiving timings.

FIG. 7A is block diagram conceptually illustrating another exemplary metric used in facilitating handover trigger mechanisms according to an aspect.

FIG. 7B is block diagram conceptually illustrating still another exemplary metric used in facilitating handover trigger mechanisms according to an aspect.

FIG. 8 is a block diagram of an exemplary wireless communications device for facilitating handover triggering mechanisms using multiple metrics according to an aspect; and

FIG. 9 is an exemplary block diagram of a network handover trigger monitoring system according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

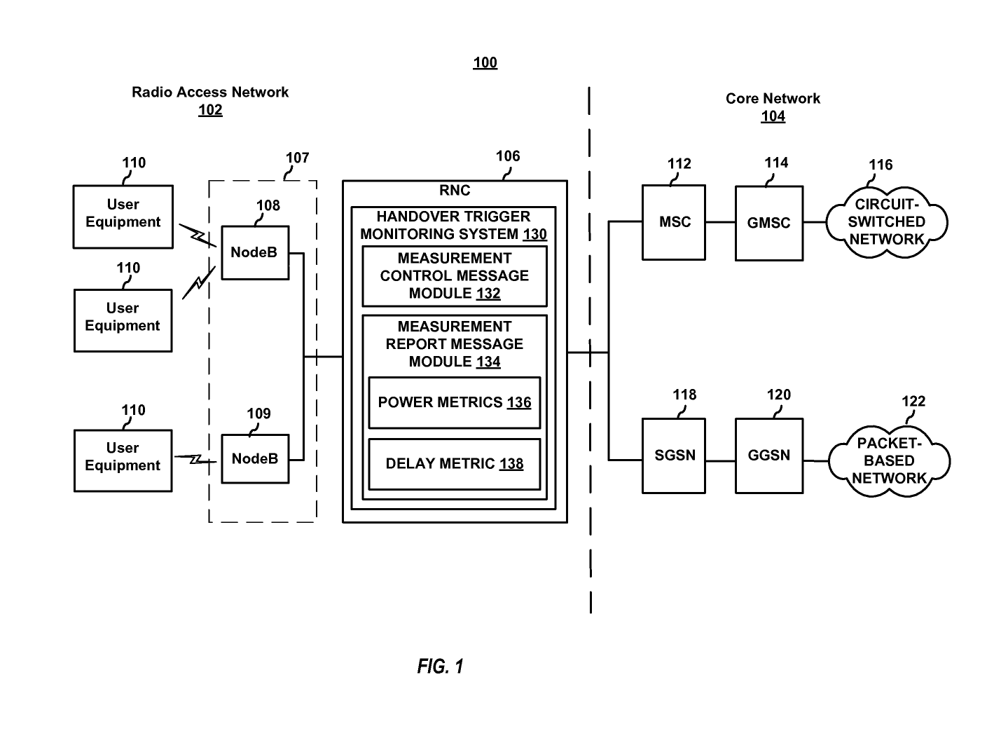

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108, 109 are shown; however, the RNS 107 may include any number of wireless Node Bs. The Node Bs 108, 109 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to a UE in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with at least one of the Node Bs 108, 109. The downlink (DL), also called the forward link, refers to the communication link from a Node B to a UE, and the uplink (UL), also called the reverse link, refers to the communication link from a UE to a Node B.

Further, RAN 102 may include a handover trigger monitoring system 130 which may be operable to monitor, coordinate and/or control the Node Bs 108. In one aspect, handover monitoring system 130 may be included within RNC 106, one or more servers, etc.

In one aspect, handover trigger monitoring system 130 may further include measurement control module 132 and measurement report module 134. Further, the measurement report module 134 may be operable to process power metrics 136 (e.g., receive signal code power (RSCP) and delay metrics 138 (e.g., a system frame number to system frame number observed time difference (SFN-SFN OTD) value, a UE internal delay metric, etc.). As used herein, a SFN-SFN OTD may be defined as the difference the beginning of a system frame from the serving cell and the beginning of a system frame from the neighbor cell.

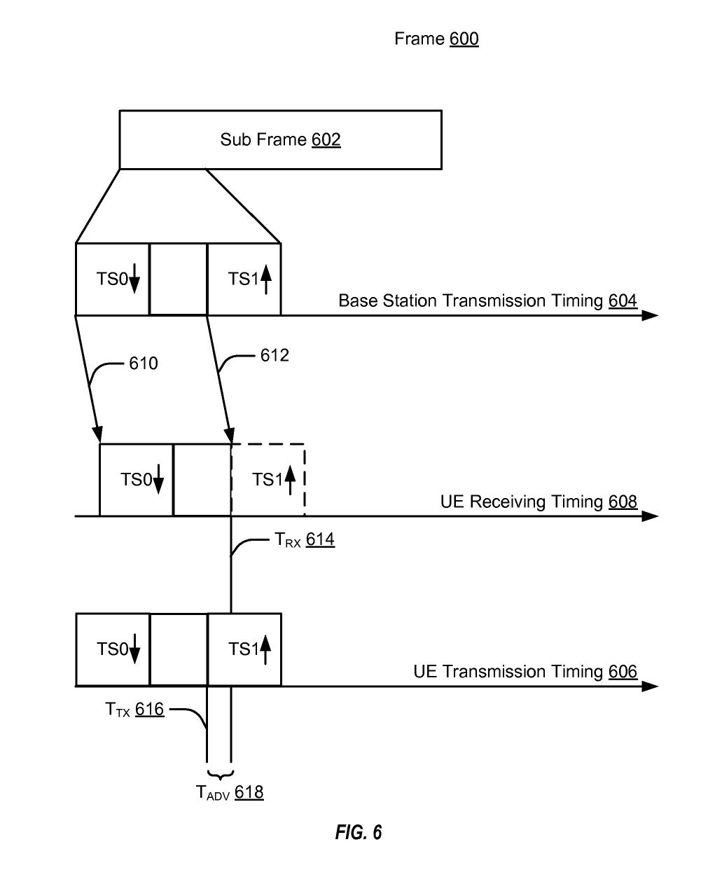

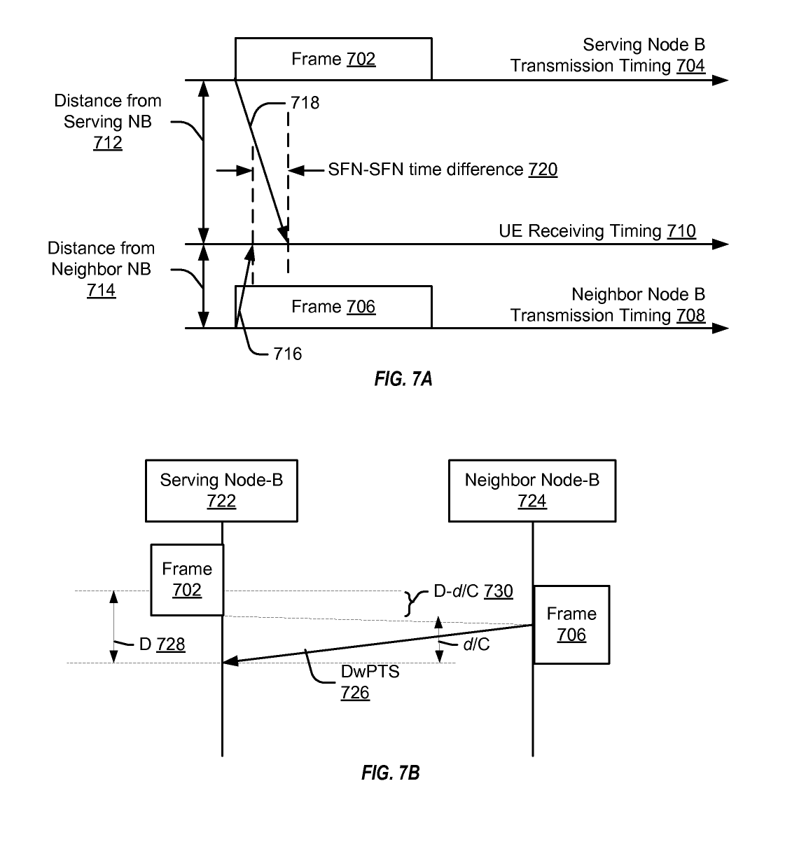

Further, in a TD-SCDMA system a scheme in which delay measurements may be used to determine whether a handover may be beneficial. Further, the TD-SCDMA standards allow the UE to report at least the following quantities in intra-frequency and inter-frequency measurement: downlink receive signal code power (DL RSCP) of Primary Common Control Physical Channel (P-CCPCH), and SFN-SFN OTD. FIGS. 7A and 7B further discuss the SFN-SFN OTD metric. In addition, the UE can be configured to generate a periodical report of a UE internal measurement report quantity: T_{ADV}. As used herein, the quantity T_{ADV} is the time advance defined by the time difference of T_{RX}-T_{TX}, where T_{RX} is calculated as a beginning time of the first uplink time slot in a first subframe used by the UE with the UE timing according to the reception of start of a certain downlink time slot, and T_{TX} is time of the beginning of the same uplink time slot by the UE with uplink synchronization. FIG. 6 further discusses the T_{ADV} metric which can indicate the round trip delay between the UE and the Node B.

In operation, one or more triggering mechanisms may be used to suggest handoff. For example, one triggering mechanism may be prompted by power-based metrics. As such, the first criterion may be to check whether the signal strength of P-CCPCH of the neighbor cell is better than the serving cell by a margin threshold (T1). Further, another criterion can be used to determine if delay metrics (e.g., round trip delay, T_{ADV,}, etc.) indicate the delay between the UE and serving cell is more than a threshold T2, which can imply that the UE is located farther from the serving cell. In one aspect, the UE may be requested to report the UE internal measurements only (e.g., delay metrics). In another aspect, the UE may be requested to report the UE internal measurements (e.g., delay metrics), after a power metric criterion has been fulfilled. Further, to choose a target cell for the internal measurements, the network may select the strongest RSCP amount the neighbor cells.

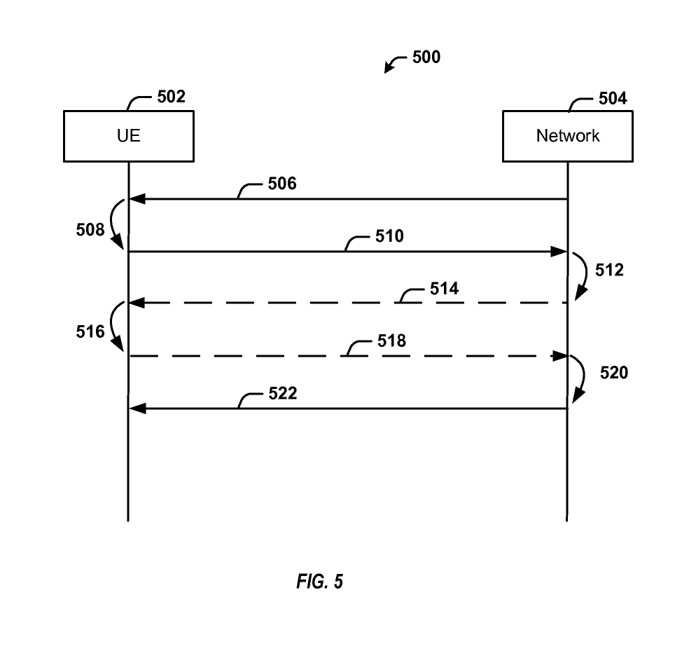

Additionally, in another aspect, another criterion can be used to determine if delay metrics (e.g., SFN-SFN OTD, etc.) indicate the delay between the serving cell and a selected neighboring Node is more than a threshold T3, which can imply that the UE is located nearer to a neighboring Node B than it is to the serving Node B. In one aspect, this criterion may be based on an assumption that Node Bs are synchronous in TD-SCDMA systems. Therefore, if SFN-SFN OTD is more than a threshold, the differential distance between the serving cell and the UE and distance between the selected neighbor cell and the UE must be greater than some margin. For example, if the threshold T3 is zero, and the SFN-SFN OTD is positive, it means a UE may be farther from the serving Node B than the target neighbor Node B. As such, to choose a neighboring Node B, the network may select a neighbor Node B with the strongest RSCP and also the neighbor Node B with the greatest SFN-SFN OTD value. These multiple criterions may be selected concurrently, in series, etc. Additionally, or in the alternative, multiple delay metrics may be used along with power metrics. For example, a handover may be triggered by any combination of a greater neighbor RSCP value than the serving cell RSCP value and sufficiently high SFN-SFN OTD and/or T_{ADV} values. Such multiple delay metrics may be analyzed in any combination and in parallel, in series, etc. Further discussion with respect to multiple metric triggered handover is discussed with respect to FIG. 5. Therefore, an efficient, robust system and/or method for providing procedures to allow handover to be triggered in a TD-SCDMA system with a greater degree of accuracy using multiple metrics may be implemented.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

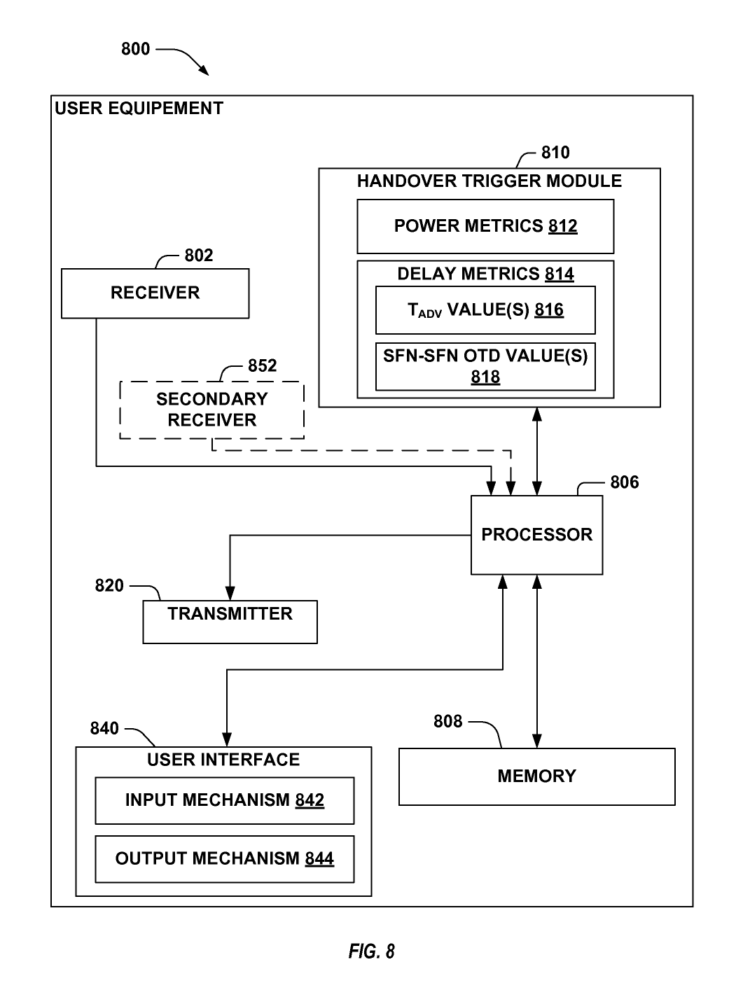

In one aspect, UE 110 may include a handover trigger module that may facilitate handover triggering mechanisms using multiple metrics. In one aspect, a handover trigger module may further include power metrics and delay metrics, wherein delay metrics may include values such as, but not limited to, T_{ADV} values, SFN-SFN OTD values, etc. Power metrics may include RSCP, etc. Further, as used herein, the quantity T_{ADV} is the time advance defined by the time difference of T_{RX}-T_{TX}, where T_{RX} is calculated as a beginning time of the first uplink time slot in a first subframe used by the UE with the UE timing according to the reception of start of a certain downlink time slot, and T_{TX} is time of the beginning of the same uplink time slot by the UE with uplink synchronization. Still further, as used herein, a SFN-SFN OTD may be defined as the difference the beginning of a system frame from the serving cell and the beginning of a system frame from the neighbor cell. A handover trigger module may aggregate such power and delay metrics to provide a serving network (e.g., a Node B, RNC, etc.) with requested metrics to determine whether to trigger a handover. An exemplary describe of a UE, such as UE 100 may be found with reference to FIG. 8.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD) rather than a frequency division duplexing (FDD) as used in many FDD mode UMTS/W-CDMA systems. TDD uses the same carrier frequency for both the UL and DL between a Node B 108 and a UE 110, but divides UL and DL transmissions into different time slots in the carrier.

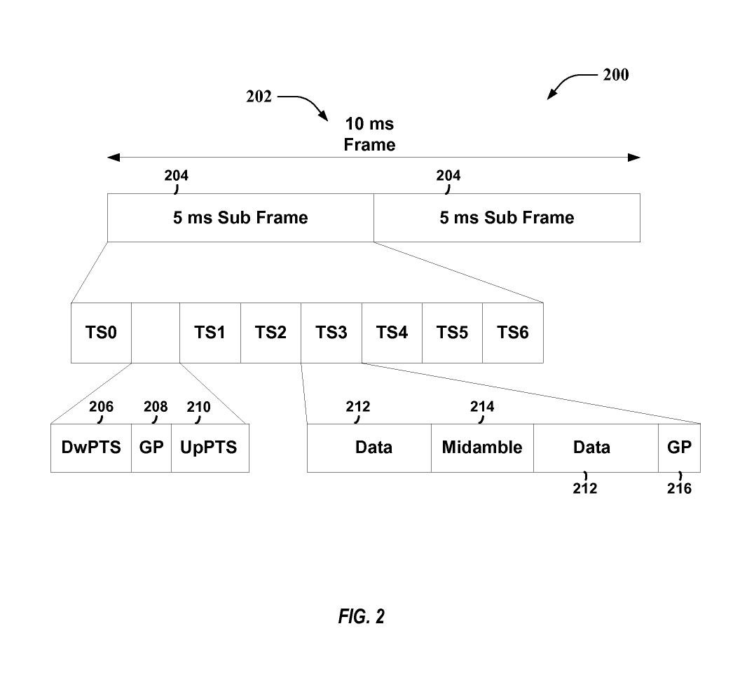

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for DL communication, while the second time slot, TS1, is usually allocated for UL communication. The remaining time slots, TS2 through TS6, may be used for either UL or DL, which allows for greater flexibility during times of higher data transmission times in either the UL or DL directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

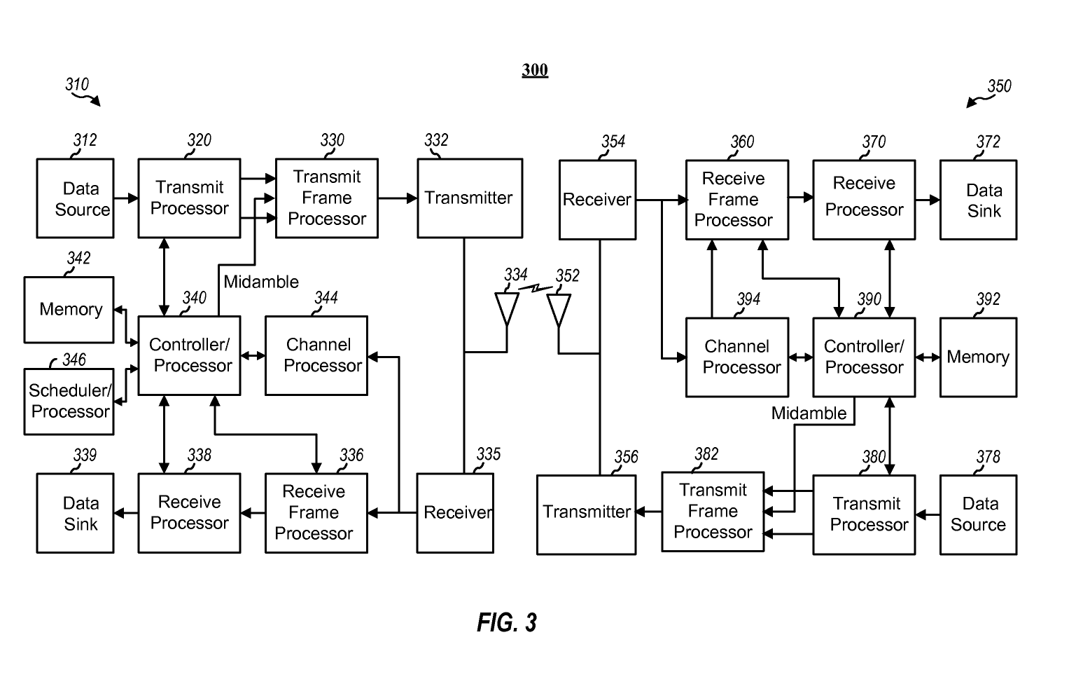

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the DL communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC) mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for DL transmission over the wireless medium through smart antennas 334. The smart antennas 334 may be implemented with beam steering bi-directional adaptive antenna arrays or other similar beam technologies.

At the UE 350, a receiver 354 receives the DL transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the DL transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule DL and/or UL transmissions for the UEs.

In one configuration, the apparatus 350 for wireless communication includes means for determining if a difference between a distance from the UE 350 to a neighbor Node B and a distance from the UE 350 to a serving Node B meets a criteria, and means for determining whether to perform a handover from said serving Node B to said neighbor Node B based on whether the determined difference meets the criteria. In one aspect, the aforementioned means may be the processor(s) 390 configured to perform the functions recited by the aforementioned means. In another aspect, the aforementioned means may be a module or any apparatus configured to perform the functions recited by the aforementioned means.

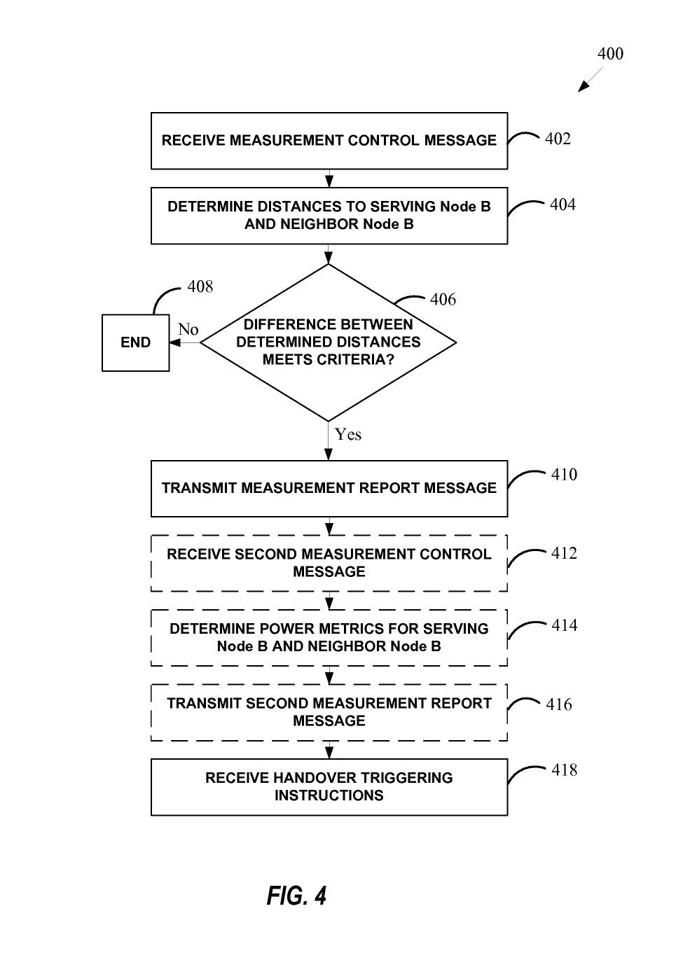

FIG. 4 is a functional block diagram 400 illustrating example blocks executed in conducting wireless communication according to one aspect of the present disclosure. In block 402, a UE may receive a measurement control message. In one aspect, the measurement control message may include content prompting the UE to perform various measurements, such as but not limited to, cells for measurement, measurement quantity (e.g., RSCP, etc.), reporting quantity, reporting criterion (e.g., periodical trigger, event type for event trigger based on the measurement quantity, event triggered periodical reporting, etc.), etc. In addition, in block 404 the UE determines various distances, such as, the distance to a serving Node B and the distance to at least one neighbor Node B. In one aspect, the distance is derived from a system frame number to system frame number observed time difference (SFN-SFN OTD) value, wherein the SFN-SFN OTD value is derived from a difference in arrival time of a frame received from the neighbor Node B and a frame received from the serving Node B. In another aspect, a correction factor may be applied to a determine SFN-SFN OTD value. In such an aspect, the correction value may be derived by determining a difference in reception time by the serving Node B for a common value transmitted by both the neighbor and serving Node Bs, determining a distance between the neighbor and serving Node B divided by a constant (e.g., the speed of light) and deriving the correction factor by subtracting the determined difference in reception time from the determined distance divided by the constant. In another aspect, the distance may be a time advance value, wherein the time advance value is derived from a difference between the UE receiving time and the UE transmission time, wherein the UE receiving time is calculated from a received downlink time slot from a transmitting Node B, and the UE transmission time is calculated from a beginning of the first uplink time slot as determined from synchronization with the transmitting Node B. In still another aspect, the distance values may be derived from any combination of the above discussed metrics.

Furthermore, in block 406 it is determined whether the differences in the determined distance meet one or more criteria. In one aspect, if it is determined that the distance to a neighbor Node B is less than a distance to a serving Node B, the one or more criteria are met. If at block 406 it is determined that the one or more criteria is not met, then in block 408, the process may end. In one aspect, the process may be performed periodically, in response to receiving a measurement control message, etc. By contrast, if at block 406 the one or more criteria are met, then in block 410, a measurement report message may be transmitted. In such an aspect, the measurement report message may prompt the serving Node B, RNC, etc., to trigger a handover.

Additionally and/or optionally, in block 412, a second measurement control message may be received to prompt the UE to measure power metrics. Further, in block 414, the UE may determine the power metrics for the serving Node B and at least one neighbor Node B. In one aspect, the power metrics may include a RSCP value. In block 416, a second measurement report message may be transmitting providing the determine power metric values. In block 418, the UE may receive a handover trigger instructions message, in response to at least one transmitted measurement report message, prompting the UE to handover over to a selected neighbor Node B.

Turning now to FIG. 5, a call flow of an exemplary system 500 for facilitating handover trigger mechanisms using multiple metrics is illustrated. Generally, UE 502 and network 504 may communicate. As used herein, network 504 may include one or more Node Bs, one or more RNCs, etc.

Returning to FIG. 5, at sequence step 506, network 504 may communicate a measurement control message to UE 502. For example, the TD-SCDMA standard provides the measurement features in which a Node B sends the measurement control message to a UE to configure the UE. As a further example, such configuring may include: cells for measurement, measurement quantity (e.g., RSCP, etc.), reporting quantity, reporting criterion (e.g., periodical trigger, event type for event trigger based on the measurement quantity, event triggered periodical reporting, etc.), etc.

At sequence step 508, UE 502 may determine if a response to the measurement control message may be appropriate, such as when one or more reporting criteria are met. At sequence step 510, when the one or more reporting criteria are met, the UE may send results in a measurement report message to the Node B. In general, there may be different types of measurement reports, for example: intra-frequency measurement, inter-frequency measurement, inter-RAT measurement, traffic volume measurement, quality measurement, UE internal measurement, and UE 502 positioning measurement. Further, in another example, based at least in part on reporting criterion, the UE can report to the network 504 once or periodically in case of event triggered periodical reporting. The UE 502 can include a few reporting quantities in the measurement reports (e.g., RSCP, etc.) for cells being reported.

At sequence step 512, the network 504 (e.g., RNC, Node B, etc.) can use this information to decide whether a handover may be beneficial. For example, if the measurement type is intra-frequency measurement, the network may use a power based measurement report, such as with a event 1G (when a neighboring node has a stronger signal than the serving node) then the report is triggered upon the change of best cell by the following equation:

Mn+On−H>Ms+Os (1)

where Mn is the measured RSCP in dBm for the neighbor cell, On is the offset for the neighbor cell, H is the hysteresis threshold, Ms is the measured RSCP in dBm for the serving cell, and Os is the offset for the serving cell

Additionally, or in the alternative, network 504 may make another measurement control request to the UE at sequence step 514. Such a message may request delay metrics from the UE. In one aspect of the process, the delay metrics request may be made only after power related metrics have indicated a handover may be beneficial. In another aspect of the process, the delay metrics request may be made contemporaneously with power metrics requests in the measurement control message. At sequence step 516, UE 502 may obtain the requested delay metrics (e.g., a SFN-SFN OTD value, a UE internal metric, T_{ADV}, etc.), and at sequence step 518, may communicate the obtained delay metrics to the network 504.

At sequence step 520, the network may analyze both power metrics and delay metrics and determine whether a handover may be beneficial for the UE 502. If the network 504 decides the handover is beneficial for the UE 502, then at sequence step 522, the UE is instructed to perform the handover. Network 504 may analyze the power metrics and delay metrics in a variety of combinations. For example, a first triggering mechanism may be prompted by power-based metrics and second criterion can be used to determine if delay metrics (e.g., round trip delay, T_{ADV}, etc.) indicate the delay between the UE and serving cell is more than a threshold T2, which can imply that the UE is located farther from the serving cell. In another example, the second criterion can be used to determine if delay metrics (e.g., SFN-SFN OTD, etc.) indicate the delay between the serving cell and a selected neighboring Node is more than a threshold T3, which can imply that the UE is located nearer to a neighboring cell than it is to the serving cell. These two second criterions may be selected concurrently, in series, etc. Additionally, or in the alternative, multiple delay metrics may be used along with power metrics. For example, a handover may be triggered by any combination of a greater neighbor RSCP value than the serving cell RSCP value and sufficiently high SFN-SFN OTD and/or T_{ADV} values. Such multiple delay metrics may be analyzed in any combination and in parallel, in series, etc.

With reference now to FIG. 6, exemplary TD-SCDMA frame structures with transmission and receiving timings are illustrated. Generally, a frame 600 may include two subframes 602 (only one subframe 602 is shown in FIG. 6), where each subframe 602 may include 7 time slots. In a TD-SCDMA system, one assumption may be that transmission timing of a Node B 604 is substantially synchronized with the transmission timing for a UE 606. Additionally, due to delays associated with propagation, etc., the UE receiving timing 608 for the start of a frame may differ from the Node B transmission timing for the start of the same frame. For example, as depicted, TS0 may be transmitted from the base station and may be received by the UE a measureable time 610 later. Likewise, timing for an uplink transmission time slot (e.g., TS1) maybe determined at a measurable time 612 later.

In one aspect, the UE can be configured to generate a periodical report of a UE internal measurement with the following report quantity: T_{ADV} (618). As used herein, the quantity T_{ADV} (618) is the time advance defined by the time difference of T_{RX}(614)-T_{TX}(616), where T_{RX} 614 is calculated as a beginning time of the first uplink time slot in a first subframe used by the UE with the UE timing according to the reception of start of a certain downlink time slot, and T_{TX} 616 is time of the beginning of the same uplink time slot by the UE with uplink synchronization.

With reference now to FIGS. 7A and 7B, exemplary metrics used in facilitating handover trigger mechanisms are illustrated. Generally, a SFN-SFN OTD value may provide the network with information related to the UE location with respect to a neighboring cell in comparison to the UE location with respect to the serving cell.

Turning now to FIG. 7A, frames 702 and 706 are depicted as being transmitted contemporaneously. This may be accomplished through synchronizing transmission timing from the serving Node B 704 and neighboring Node B 708. In such an aspect, the UE receiving timing 710 for the frames 702, 706 may be proportional to the distance from the serving Node B 712 and the distance from the neighbor Node B 714. For example, frame 702 takes a measureable time 718 to travel the distance between the serving Node B and the UE 712, additionally, frame 706 takes a measureable time 716 to travel the distance between the neighbor Node B and the UE 714. The difference in arrival times may be measured to determine a SFN-SFN OTD value 720.

Turning now to FIG. 7B, in some aspect, different Node Bs (722, 724) may not be perfectly synchronous, and there may be some small timing drift that can affect the accuracy. To correct such an error, the serving Node B 722 can measure the timing of DwPTS (Downlink Pilot Time Slot) signal 726 received from a neighbor Node B 724. This value may then be compared with its own transmission timing of DwPTS. Any delay may be measured as D 728. Note, as used herein, D 728 results in a positive value if the received neighbor DwPTS 726 arrives later than transmission timing of the serving Node B 722. If the distance between neighbor Node B and serving Node B, denoted by d, is known and/or pre-configured at the serving Node B 722, then a correction factor (D−d/C) 730 may be calculated, where C is the speed of light. The calculated correction factor may be used with the SFN-SFN OTD value to provide an additional and/or alternative delay metric: SFN-SFN OTD+(D−d/C)>T3.

With reference now to FIG. 8, an illustration of a User Equipment (UE) 800 (e.g., a client device, wireless communications device (WCD), etc.) that can facilitate handover triggering mechanisms using multiple metrics is presented. UE 800 comprises receiver 802 that receives one or more signal from, for instance, one or more receive antennas (not shown) performs typical actions on (e.g., filters, amplifies, downconverts, etc.) the received signal, and digitizes the conditioned signal to obtain samples. Receiver 802 can further comprise an oscillator that can provide a carrier frequency for demodulation of the received signal and a demodulator that can demodulate received symbols and provide them to processor 806 for channel estimation. In one aspect, UE 800 may further comprise secondary receiver 852 and may receive additional channels of information.

Processor 806 can be a processor dedicated to analyzing information received by receiver 802 and/or generating information for transmission by one or more transmitters 820 (for ease of illustration, only one transmitter is shown) a processor that controls one or more components of WCD 800, and/or a processor that both analyzes information received by receiver 802 and/or secondary receiver 852, generates information for transmission by transmitter 820 for transmission on one or more transmitting antennas (not shown) and controls one or more components of UE 800.

In one configuration, the UE 800 includes means for determining if a difference between a distance from the UE 800 to a neighbor Node B and a distance from the UE 800 to a serving Node B meets a criteria, and means for determining whether to perform a handover from said serving Node B to said neighbor Node B based on whether the determined difference meets the criteria. In one aspect, the aforementioned means may be the processor 806 configured to perform the functions recited by the aforementioned means. In another aspect, the aforementioned means may be a module or any apparatus configured to perform the functions recited by the aforementioned means.

UE 800 can additionally comprise memory 808 that is operatively coupled to processor 806 and that can store data to be transmitted, received data, information related to available channels, data associated with analyzed signal and/or interference strength, information related to an assigned channel, power, rate, or the like, and any other suitable information for estimating a channel and communicating via the channel. Memory 808 can additionally store protocols and/or algorithms associated with estimating and/or utilizing a channel (e.g., performance based, capacity based, etc.).

It will be appreciated that the data store (e.g., memory 808) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 808 of the subject systems and methods is intended to comprise, without being limited to, these and any other suitable types of memory.

UE 800 can further handover trigger module 810 that facilitates handover triggering mechanisms using multiple metrics from the UE 800. In one aspect of the UE 800, handover trigger module 810 may further include power metrics 812 and delay metrics 814, wherein delay metrics may include values such as, but not limited to, T_{ADV} values 816, SFN-SFN OTD values 818, etc. Power metrics 812 may include RSCP, etc. Further, as used herein, the quantity T_{ADV} is the time advance defined by the time difference of T_{RX}-T_{TX}, where T_{RX} is calculated as a beginning time of the first uplink time slot in a first subframe used by the UE with the UE timing according to the reception of start of a certain downlink time slot, and T_{TX} is time of the beginning of the same uplink time slot by the UE 800 with uplink synchronization. Still further, as used herein, a SFN-SFN OTD 818 may be defined as the difference the beginning of a system frame from the serving cell and the beginning of a system frame from the neighbor cell. Handover trigger module 810 may aggregate such power and delay metrics to provide the serving network with requested metrics to determine whether a handover should occur.

Additionally, UE 800 may include user interface 840. User interface 840 may include input mechanisms 842 for generating inputs into UE 800, and output mechanism 844 for generating information for consumption by the user of wireless device 800. For example, input mechanism 842 may include a mechanism such as a key or keyboard, a mouse, a touch-screen display, a microphone, etc. Further, for example, output mechanism 844 may include a display, an audio speaker, a haptic feedback mechanism, a Personal Area Network (PAN) transceiver etc. In the illustrated aspects, output mechanism 844 may include a display operable to present content that is in image or video format or an audio speaker to present content that is in an audio format.

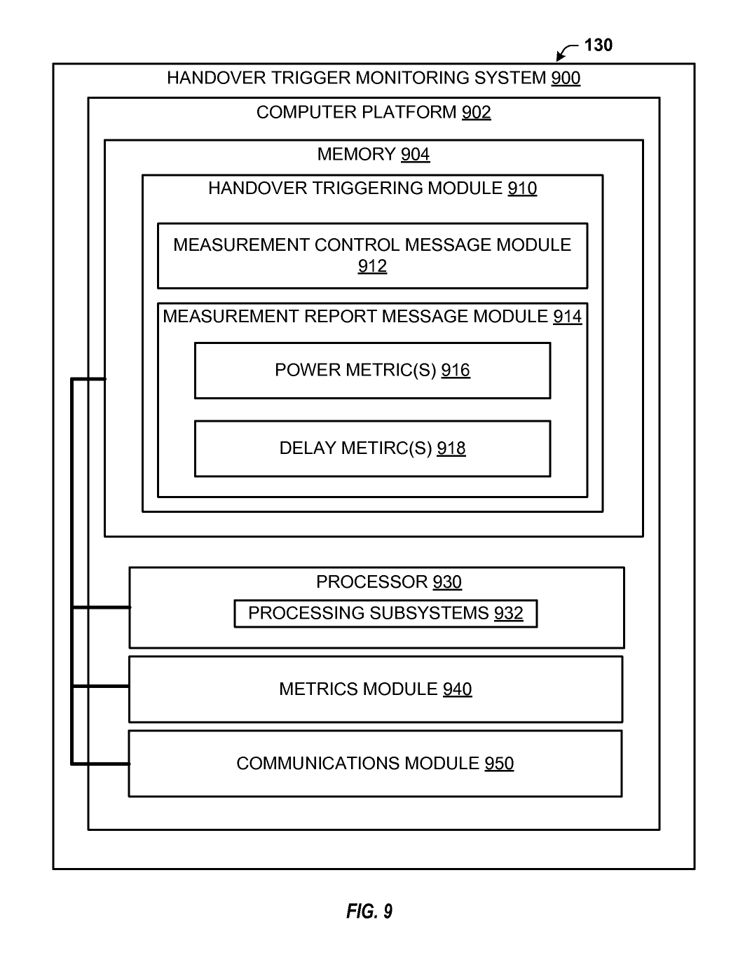

With reference to FIG. 9, illustrated is a detailed block diagram of handover trigger monitoring system 900, such as handover trigger monitoring system 130 depicted in FIG. 1. Handover trigger monitoring system 900 may comprise at least one of any type of hardware, server, personal computer, mini computer, mainframe computer, or any computing device either special purpose or general computing device. Further, the modules and applications described herein as being operated on or executed by handover trigger monitoring system 900 may be executed entirely on a single network device, as shown in FIG. 9, or alternatively, in other aspects, separate servers, databases or computer devices may work in concert to provide data in usable formats to parties, and/or to provide a separate layer of control in the data flow between UEs 110, Node Bs 108, 109, and the modules and applications executed by handover trigger monitoring system 900.

Handover trigger monitoring system 900 includes computer platform 902 that can transmit and receive data across wired and wireless networks, and that can execute routines and applications. Computer platform 902 includes memory 904, which may comprise volatile and nonvolatile memory such as read-only and/or random-access memory (ROM and RAM), EPROM, EEPROM, flash cards, or any memory common to computer platforms. Further, memory 904 may include one or more flash memory cells, or may be any secondary or tertiary storage device, such as magnetic media, optical media, tape, or soft or hard disk. Still further, computer platform 902 also includes processor 930, which may be an application-specific integrated circuit (“ASIC”), or other chipset, logic circuit, or other data processing device. Processor 930 may include various processing subsystems 932 embodied in hardware, firmware, software, and combinations thereof, that enable the functionality of handover trigger module 910 and the operability of the network device on a wired or wireless network.

Computer platform 902 further includes communications module 950 embodied in hardware, firmware, software, and combinations thereof that enables communications among the various components of handover trigger monitoring system 900, as well as between handover trigger monitoring system 900 and Node Bs 108, 109. Communication module 950 may include the requisite hardware, firmware, software and/or combinations thereof for establishing a wireless communication connection. According to described aspects, communication module 950 may include hardware, firmware and/or software to facilitate wireless broadcast, multicast and/or unicast communication of requested cell, Node B, UE, etc., measurements.

Computer platform 902 further includes metrics module 940, embodied in hardware, firmware, software, and combinations thereof, that enables metrics received from Node Bs 108, 109 corresponding to, among other things, data communicated from UEs 110. In one aspect, handover trigger monitoring system 900 may analyze data received through metrics module 940 monitor network health, capacity, usage, etc. For example, if the metrics module 940 returns data indicating that one or more of a plurality of Node Bs are inefficient, then the handover trigger monitoring system 900 may suggest that UEs 110 handover away from said inefficient base station.

Memory 904 of handover trigger monitoring system 900 includes network handover trigger module 910 operable for assisting in network determinations regarding UE handovers. In one aspect, handover trigger module 910 may include measurement control message module 912, and measurement report message module 914, wherein measurement report message module may further include power metrics 916 and delay metrics 918.

In one aspect, measurement control message module 912 may use to transmit a measurement control message to a UE. For example, the TD-SCDMA standard measurement control message may request measurement of UE functions, such as: cells for measurement, measurement quantity (e.g., RSCP, etc.), reporting quantity, reporting criterion (e.g., periodical trigger, event type for event trigger based on the measurement quantity, event triggered periodical reporting, etc.). In another aspect, measurement report message module 914 may be operable to receive power metrics 916 and delay metrics 918 from a UE received in response to the measurement control message. Power metrics 916 may include RSCP, etc. Further, delay metrics 918 may include values such as, but not limited to, T_{ADV} values, SFN-SFN OTD values, etc. As used herein, the quantity T_{ADV} is the time advance defined by the time difference of T_{RX}-T_{TX}, where T_{RX} is calculated as a beginning time of the first uplink time slot in a first subframe used by the UE with the UE timing according to the reception of start of a certain downlink time slot, and T_{TX} is time of the beginning of the same uplink time slot by the UE with uplink synchronization. Still further, as used herein, a SFN-SFN OTD 818 may be defined as the difference the beginning of a system frame from the serving cell and the beginning of a system frame from the neighbor cell.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a time division synchronous code division multiple access (TD-SCDMA) system, comprising:
determining if a difference between a distance from a UE to a neighbor Node B and a distance from the UE to a serving Node B meets a criteria; and
determining whether to perform a handover from said serving Node B to said neighbor Node B based on whether the determined difference meets the criteria.

2. The method of claim 1, further comprising:
receiving a first measurement control message requesting the UE to determine the distances to the serving Node B and the neighbor Node B.

3. The method of claim 1, wherein the distance is derived from a system frame number to system frame number observed time difference (SFN-SFN OTD) value, wherein the SFN-SFN OTD value is derived from a difference in arrival time of a frame received from the neighbor Node B and a frame received from the serving Node B.

4. The method of claim 3, further comprising:
determining that the neighbor Node B and the serving Node B are not transmitting within a defined of time of each other, and
generating a correction factor to apply to the SFN-SFN OTD value, wherein the generating the correction factor further comprises:
determining a difference in reception time by the serving Node B for a common value transmitted by both the neighbor and serving Node Bs;
determining a distance between the neighbor and serving Node B divided by a constant; and
deriving the correction factor by subtracting the determined difference in reception time from the determined distance divided by the constant.

5. The method of claim 1, wherein the distance is derived from a time advance value, wherein the time advance value is derived from a difference between the UE receiving time and the UE transmission time, wherein the UE receiving time is calculated from a received downlink time slot from a transmitting Node B, and the UE transmission time is calculated from a beginning of the first uplink time slot as determined from synchronization with the transmitting Node B.

6. The method of claim 1, wherein the distance is derived from a value derived from an aggregation of values derived from a SFN-SFN OTD value and a time advance value.

7. The method of claim 1, further comprising:
determining one or more power metrics associated with the serving Node B and the neighbor Node B; and
wherein the determining whether to perform the handover from said serving Node B to said neighbor Node B further comprises determining whether to perform the handover based on whether the determined at least one of the one or more power metrics associated with the neighbor Node B is greater than the corresponding at least one power metric for the serving Node B.

8. The method of claim 7, wherein the one of the one or more power metrics comprises a receive signal code power (RSCP) value.

9. The method of claim 1, further comprising:
transmitting a measurement report message in response to the determination to perform the handover.

10. The method of claim 1, wherein the determination to not perform a handover occurs when the criteria is met.

11. An apparatus for wireless communication in a time division synchronous code division multiple access (TD-SCDMA) system, comprising:
means for determining if a difference between a distance from a UE to a neighbor Node B and a distance from the UE to a serving Node B meets a criteria; and
means for determining whether to perform a handover from said serving Node B to said neighbor Node B based on whether the determined difference meets the criteria.

12. The apparatus of claim 11, further comprising:
means for receiving a first measurement control message requesting the UE to determine the distances to the serving Node B and the neighbor Node B.

13. The apparatus of claim 11, wherein the distance is derived from a system frame number to system frame number observed time difference (SFN-SFN OTD) value, wherein the SFN-SFN OTD value is derived from a difference in arrival time of a frame received from the neighbor Node B and a frame received from the serving Node B.

14. The apparatus of claim 13, further comprising:
means for determining that the neighbor Node B and the serving Node B are not transmitting within a defined of time of each other, and
means for generating a correction factor to apply to the SFN-SFN OTD value, wherein the generating the correction factor further comprises:
means for determining a difference in reception time by the serving Node B for a common value transmitted by both the neighbor and serving Node Bs;
means for determining a distance between the neighbor and serving Node B divided by a constant; and
means for deriving the correction factor by subtracting the determined difference in reception time from the determined distance divided by the constant.

15. The apparatus of claim 11, wherein the distance is derived from a time advance value, wherein the time advance value is derived from a difference between the UE receiving time and the UE transmission time, wherein the UE receiving time is calculated from a received downlink time slot from a transmitting Node B, and the UE transmission time is calculated from a beginning of the first uplink time slot as determined from synchronization with the transmitting Node B.

16. The apparatus of claim 11, wherein the distance is derived from a value derived from an aggregation of values derived from a SFN-SFN OTD value and a time advance value.

17. The apparatus of claim 11, further comprising:
means for determining one or more power metrics associated with the serving Node B and the neighbor Node B; and
wherein the means for determining whether to perform the handover from said serving Node B to said neighbor Node B further comprises means for determining whether to perform the handover based on whether the determined at least one of the one or more power metrics associated with the neighbor Node B is greater than the corresponding at least one power metric for the serving Node B.

18. The apparatus of claim 17, wherein the one of the one or more power metrics comprises a receive signal code power (RSCP) value.

19. The apparatus of claim 11, further comprising:
means for transmitting a measurement report message in response to the determination to perform the handover.

20. The apparatus of claim 11, wherein the determination to not perform a handover occurs when the criteria is met.

21. A computer program product, comprising:
a computer-readable medium comprising code for:
determining if a difference between a distance from a UE to a neighbor Node B and a distance from the UE to a serving Node B meets a criteria; and
determining whether to perform a handover from said serving Node B to said neighbor Node B based on whether the determined difference meets the criteria.

22. The computer program product of claim 21, wherein the computer-readable medium further comprises code for:
receiving a first measurement control message requesting the UE to determine the distances to the serving Node B and the neighbor Node B.

23. The computer program product of claim 21, wherein the distance is derived from a system frame number to system frame number observed time difference (SFN-SFN OTD) value, wherein the SFN-SFN OTD value is derived from a difference in arrival time of a frame received from the neighbor Node B and a frame received from the serving Node B.

24. The computer program product of claim 23, wherein the computer-readable medium further comprises code for:
determining that the neighbor Node B and the serving Node B are not transmitting within a defined of time of each other, and
generating a correction factor to apply to the SFN-SFN OTD value, wherein the generating the correction factor further comprises:
determining a difference in reception time by the serving Node B for a common value transmitted by both the neighbor and serving Node Bs;
determining a distance between the neighbor and serving Node B divided by a constant; and
deriving the correction factor by subtracting the determined difference in reception time from the determined distance divided by the constant.

25. The computer program product of claim 21, wherein the distance is derived from a time advance value, wherein the time advance value is derived from a difference between the UE receiving time and the UE transmission time, wherein the UE receiving time is calculated from a received downlink time slot from a transmitting Node B, and the UE transmission time is calculated from a beginning of the first uplink time slot as determined from synchronization with the transmitting Node B.

26. The computer program product of claim 21, wherein the distance is derived from a value derived from an aggregation of values derived from a SFN-SFN OTD value and a time advance value.

27. The computer program product of claim 26, wherein the computer-readable medium further comprises code for:
determining one or more power metrics associated with the serving Node B and the neighbor Node B; and
wherein the determining whether to perform the handover from said serving Node B to said neighbor Node B further comprises determining whether to perform the handover based on whether the determined at least one of the one or more power metrics associated with the neighbor Node B is greater than the corresponding at least one power metric for the serving Node B.

28. The computer program product of claim 27, wherein the one of the one or more power metrics comprises a receive signal code power (RSCP) value.

29. The computer program product of claim 21, wherein the computer-readable medium further comprises code for:
transmitting a measurement report message in response to the determination to perform the handover.

30. The computer program product of claim 21, wherein the determination to not perform a handover occurs when the criteria is met.

31. An apparatus for wireless communication in a time division synchronous code division multiple access (TD-SCDMA) system, comprising:
at least one processor; and
a memory coupled to the at least one processor,
wherein the at least one processor is configured to:
determine if a difference between a distance from a UE to a neighbor Node B and a distance from the UE to a serving Node B meets a criteria; and
determine whether to perform a handover from said serving Node B to said neighbor Node B based on whether the determined difference meets the criteria.

32. The apparatus of claim 31, wherein the at least one processor is further configured to:
receive a first measurement control message requesting the UE to determine the distances to the serving Node B and the neighbor Node B.

33. The apparatus of claim 31, wherein the distance is derived from a system frame number to system frame number observed time difference (SFN-SFN OTD) value, wherein the SFN-SFN OTD value is derived from a difference in arrival time of a frame received from the neighbor Node B and a frame received from the serving Node B.

34. The apparatus of claim 33, wherein the at least one processor is further configured to:
determine that the neighbor Node B and the serving Node B are not transmitting within a defined of time of each other, and
generate a correction factor to apply to the SFN-SFN OTD value, wherein the at least one processor configured to generate the correction factor is further configured to:
determine a difference in reception time by the serving Node B for a common value transmitted by both the neighbor and serving Node Bs;
determine a distance between the neighbor and serving Node B divided by a constant; and
derive the correction factor by subtracting the determined difference in reception time from the determined distance divided by the constant.

35. The apparatus of claim 31, wherein the distance is derived from a time advance value, wherein the time advance value is derived from a difference between the UE receiving time and the UE transmission time, wherein the UE receiving time is calculated from a received downlink time slot from a transmitting Node B, and the UE transmission time is calculated from a beginning of the first uplink time slot as determined from synchronization with the transmitting Node B.

36. The apparatus of claim 31, wherein the distance is derived from a value derived from an aggregation of values derived from a SFN-SFN OTD value and a time advance value

37. The apparatus of claim 31, wherein the at least one processor is further configured to:
determine one or more power metrics associated with the serving Node B and the neighbor Node B; and
wherein the determination whether to perform the handover from said serving Node B to said neighbor Node B further comprises the at least one processor configured to determine whether to perform the handover based on whether the determined at least one of the one or more power metrics associated with the neighbor Node B is greater than the corresponding at least one power metric for the serving Node B.

38. The apparatus of claim 37, wherein the one of the one or more power metrics comprises a receive signal code power (RSCP) value.

39. The apparatus of claim 31, wherein the at least one processor is further configured to:
transmit a measurement report message in response to the determination to perform the handover.

40. The apparatus of claim 31, wherein the determination to not perform a handover occurs when the criteria is met.
